(19) United States
(12) Patent Application Publication
(10) Pub. No.: US 2005/0262352 A1
(43) Pub. Date: Nov. 24, 2005

(54) Method for sending digital copies of protected media and network access device

(75) Inventors: Marcus Kessler, Stuttgart (DE); Marco Tomsu, Ditzingen (DE); Peter Domschitz, Stuttgart (DE)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/109,791

(22) Filed: Apr. 20, 2005

(30) Foreign Application Priority Data
May 7, 2004 (EP) 04 291 192.5

(51) Int. Cl. G06F 7/00

(52) U.S. Cl. 713/176

(57) ABSTRACT

Method for sending digital copies of protected media, using receiver-individual digital watermarks, from a media server via a telecommunications network and a network access device with connecting devices to an end user terminal, in which a digital copy which is to be sent to a specific end user terminal of the telecommunications network is made available in the network access device from which the end user terminal is connected to the telecommunications network in which the digital copy provided with the digital watermark is sent to the end user terminal via the connecting device of the network access device via which this end user terminal is connected, the digital watermark being imprinted into the digital copy to be sent in this network access device, wherein the digital watermark contains at least data acting as identification of the end user to whom the digital copy is to be sent.

The invention is based on a priority application EP 04 291 192.5 which is hereby incorporated by reference.

### TECHNICAL FIELD

The invention relates to a method for sending digital copies of protected media, using receiver-individual digital watermarks, from a media server via a telecommunications network and a network access device with connecting devices to an end user terminal, in which a digital copy which is to be sent to a specific end user terminal of the telecommunications network is made available in the network access device from which the end user terminal is connected to the telecommunications network in which the digital copy provided with the digital watermark is sent to the end user terminal via the connecting device of the network access device via which this end user terminal is connected and network access device with connecting devices for connecting end user terminals of a telecommunications network to this telecommunications network by means of user-individually safeguarded connection channels, in particular for connecting to the internet.

### BACKGROUND OF THE INVENTION

The rapidly growing number of broadband connections, such as ADSL, for example, for private customers has also caused a sharp increase in the demand for high-quality multimedia services requiring a large band width, such as video-on-demand, for example, or downloading music from the internet. These data are transmitted in digital form and are of a quality comparable to a DVD or CD. Data properties of this kind in turn enable the production of a large number of copies of the data without loss of quality and thereby of course also the production and distribution of illegal copies.

In order to master this problem, the concept of the electronic watermark, in which the data are electronically marked, has been introduced in the transmission of media. This marking is here imprinted by only small changes in the signals to be transmitted and is therefore not perceptible to human senses. By a suitable choice of encrypting for the watermark it is additionally achieved that the watermark is inseparably linked to the data to be transmitted. Based on the information on the sender and the receiver of the data contained in the watermark of the copy, it can clearly be concluded from the copies whether the owner has obtained them legally, in other words is identical to the receiver, or whether they are pirated copies.

WO patent 01/67667 describes how receiver-specific watermarks are used in combination with encrypting techniques in order thereby to be able both to determine the origin of unauthorised copies and also to increase the probability that only the rightful receiver can reproduce the media contents by means of a key.

Currently the only possibility is to attach the watermark in a media server, which in the case of transmission of the same data to many or even all end users based on the receiver-individual watermark means that for every receiver a separate marked data stream has to be sent from the server via the network and the network access device to the end user. As this leads to extraordinarily high server and network utilisation, receiver-individual marking of the data in this way is impracticable. Additionally, there is no guarantee that the receiver of the data has actually ordered them and is therefore the rightful owner, as the data can be intercepted on the way from the server to the network access device, even if the data are being transmitted encrypted. Watermarks imprinted into the data stream in the server are therefore suitable only for identifying the sender, i.e. the holder of the copyright, but not for identification of the receiver beyond reasonable doubt. Watermarks of this kind are useful for producers of CDs and DVDs and for the police to identify forgeries in which the copyright marking is missing or is incorrect, but this hardly discourages software pirates from making forgeries or pirated copies.

An alternative possibility of preventing pirated copies is to incorporate copy protection, such as TCPA (trusted computing platform architecture), for example, in the terminals of the end users. These kinds of copy protection enable the media data to be reproduced only with specific reproduction equipment and thus prevent the reproduction of pirated copies on reproduction equipment other than that originally provided. However, this also stops the legal reproduction of private copies on other reproduction equipment, representing a curtailment of the rights obtained with the purchase of the media.

The object of the invention is to create a way of alleviating the above-described situation.

This object is achieved according to the invention by a method for sending digital copies of protected media, using receiver-individual digital watermarks, from a media server via a telecommunications network and a network access device with connecting devices to an end user terminal, in which a digital copy which is to be sent to a specific end user terminal of the telecommunications network is made available in the network access device from which the end user terminal is connected to the telecommunications network in which the digital copy provided with the digital watermark is sent to the end user terminal via the connecting device of the network access device via which this end user terminal is connected and by a network access device with connecting devices for connecting end user terminals of a telecommunications network to this telecommunications network by means of user-individually safeguarded connection channels, in particular for connecting to the internet.

### SUMMARY OF THE INVENTION

Any kind of marking, for individualising multimedia contents, for example, is performed by a network access device assigned to the respective end user and located in the path between the media server and the end user terminal. As this path is represented either by a separate line or a virtual connection, it can very reliably be guaranteed that the individualised media contents can really be received only by the rightful owner. Therefore in turn the origin of illegal copies can also be very reliably discovered.

Each end user, as mentioned, is connected by a special virtual or physical connection to a special network access device. This puts the provider of the network access (network access provider or abbreviated NAP), as owner of the bit transmission layer (physical layer), in a position to identify the end user requesting a service. Provided that there is a contract between the provider of services and the provider of the network access, the latter can institute a service object based on software or hardware in the network access device assigned to the end user. The functionality of this service object is similar to code conversion in media. The end user identity in conjunction with other transaction data, such as the identity of the owner of the copyright or the date of the download, for example, is attached to the multimedia contents being transmitted via the network access device in the form of a watermark. In this way a clear link between the service provider, the service itself and the end user is produced and enables the prosecution of pirate copiers. Removal of the watermark is possible only by accepting great losses in quality. As the watermark is attached to the data stream in the network access element assigned to the end user, this method is suitable not only for individual downloads or streaming, but also for transmitting multimedia contents to several end users simultaneously or even for broadcast messages. The method is further also suitable for providing multimedia contents if these multimedia contents are stored in a cache, wherein in this case the watermark is not attached until after the data have been fetched from the cache.

Instituting service objects of this kind with which watermarks can be attached to multimedia contents in the network access devices can take place for each end user individually, without there being unacceptably strong demands on the network capacity, as would be the case if the individual markings were to be attached in the media server. This also enables individual marking by means of watermarks in the case of transmission of the same data to many or even all the end users.

Attaching these individual, non-removable watermarks does not require any kind of expensive changes or extensions of the devices on the part of the end user or service provider and can therefore be executed flexibly and at a reasonable price.

Attaching the watermark in a network access device assigned to the end user additionally reduces the risk of incorrect assignment of watermarks and content.

The method is above all tailored to telecommunications companies acting as network access providers, as they hold exclusive control over the network access device and therefore can take on the attachment of the watermarks.

Based on the network access provider's control over the network access device and the technical implementation of the path between the network access device and the end user terminal by a separate line or a virtual connection, this connection between the network access device and the end user terminal is relatively-secure and the danger of data manipulation and pirated copying is thereby minimised. It is quite possible for transmission of the multimedia contents also to be encrypted on the network path between the media server and the network access device, in order thereby to obtain additional security against pirated copying.

By the method described end users retain the facility, which is also theirs by right, of making security copies.

The contractual cooperation between the service provider and the network access provider opens up for the service provider potential access to the large pool of customers of the network access provider and therefore the prospect of additional commissions. Additionally, multimedia services can thereby be combined with additional services, such as payment services and the like, for example, likewise offered by the network access providers.

### BRIEF DESCRIPTION OF THE DRAWINGS

Further configurations of the invention are to be found in the subordinate claims and the following description.

The invention is explained in greater detail below with the aid of the attached drawing.

FIG. 1 shows as an example a network environment in which the invention can be implemented.

### DETAILED DESCRIPTION OF PREFERRED EMBODIMENTS

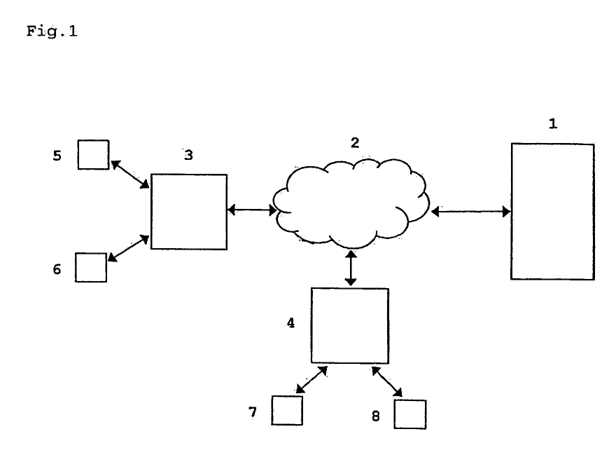

The network environment from FIG. 1 contains a media server (1), a telecommunications network (2), network access devices (3, 4) according to the invention and end user terminals (5-8). The media server (1) can communicate with a plurality of end user terminals (5-8) via the telecommunications network (2) and the network access terminals (3, 4).

The telecommunications network (2) may in this case be the internet, but also any other network, such as a so-called Local Area Network (LAN) or a Wide Area Network (WAN), for example. This telecommunications network (2) can in this case be implemented both in a fixed network and in a mobile radio environment.

The media server (1) is a network terminal for communicating via the telecommunications network (2). This media server (1) can in this case either simply be a computer which acts, e.g., as a web server, or also include special network functions, such as those of a router, switch or gateway, for example. The media server (1) additionally has means for storing media, such as hard disks, compact disks (CDs), digital versatile disks (DVDs) or similar, for example. The media may consist of video and/or audio data, such as MPEG data (MPEG=moving picture experts group), for example, or similar data. For communication via the telecommunications network (2) the media server (1) has means both for processing and for receiving and/or sending media.

The network access devices (3, 4) according to the invention have means for receiving, sending, storing and processing data, such as digital copies of media, for example. The means for processing data enable digital watermarks, which contain at least data acting as identification of the end user to whom the digital copies are to be sent, to be imprinted into the digital copies to be sent. The network access device (3, 4) is connected to the telecommunications network (2), such as the internet, for example, via one or more connecting devices. Via further connecting devices of the network access devices (3, 4) there is the possibility of data exchange with end user terminals (5-8) connected by means of virtual connections.

In a further embodiment the network access devices (3, 4) have means which enable the decoding of encrypted digital copies which the network access devices (3, 4) have received via the connecting devices to the telecommunications network (2). Encrypting the data on the path between the media server (1) and the network access devices (3, 4) acts in this case as additional security against illegal copying.

In a further embodiment the network access devices (3, 4) have means which enable the encrypting of digital copies into which digital watermarks have previously been imprinted and which after encrypting are sent via the connecting devices to the appropriate end user terminals (5-8). Encrypting the data on the path between the network access devices (3, 4) and the end user terminals (5-8) in this case acts as additional security against illegal copying.

The end user terminals (5-8) can receive the digital copies which are sent to them via a special physical or virtual connection by one of the network access devices (3, 4). The end user terminals (5-8) can be implemented as computers, such as personal computers (PC) or laptop computers, for example, but also again represent a media server. Additionally, the end user terminals (5-8) may also stand for portable electronic equipment, such as the personal data assistant (PDA) or mobile telephones, for example. Applications such as Windows Media Player™ or Real Player™, for example, can run on the end user terminals (5-8) to illustrate the received digital copies of the media.

In the method according to the invention digital copies of media are sent by the media server (1) via the telecommunications network (2) and a network access device (3, 4) to one of the end user terminals (5-8), a digital watermark being imprinted into the digital copy in the network access device (3,4). This digital watermark contains at least information acting as identification of the end user for whom the digital copy is intended, but can additionally also contain, for example, information on the data source or the date of sending. The digital copy provided with the digital watermark is then sent via the connecting device of the network access device (3, 4) via which the respective end user for whom the digital copy is intended is connected.

In a further embodiment the digital copies of the media in the media server (1) are first encrypted before they are sent by the media server (1) via the telecommunications network (2) to the network access device (3, 4). In the network access device (3, 4) the digital copies are decoded again before the digital watermarks are imprinted into the digital copies and they are then sent to the end user terminals (5-8).

In a further embodiment the digital copies of the media in the network access device (3, 4) are encrypted after the digital watermarks have been imprinted into the digital copies and then the digital copies are sent encrypted to the end user terminals (5-8).

1. Method for sending digital copies of protected media, using receiver-individual digital watermarks, from a media server via a telecommunications network and a network access device with connecting devices to an end user terminal, in which a digital copy which is to be sent to a specific end user terminal of the telecommunications network is made available in the network access device from which the end user terminal is connected to the telecommunications network in which the digital copy provided with the digital watermark is sent to the end user terminal via the connecting device of the network access device via which this end user terminal is connected, wherein the digital watermark in this network access device is imprinted into the digital copy to be sent, the digital watermark containing at least data acting as identification of the end user to whom the digital copy is being sent.

2. Method according to claim 1, wherein the digital copy is sent encrypted between the media server via the telecommunications network to the network access device and in the network access device is decoded before the digital watermark is imprinted into the digital copy and it is sent to the end user terminal.

3. Method according to claim 1, wherein the digital copy is encrypted after imprinting of the digital watermark and before sending to the end user terminal.

4. Network access device with connecting devices for connecting end user terminals of a telecommunications network to this telecommunications network by means of user-individually safeguarded connection channels, in particular for connecting to the internet, wherein the network access device has means for making available a digital copy which is to be sent to a specific end user terminal of a telecommunications network, for imprinting a digital watermark into the digital copy to be sent, the digital watermark containing at least data acting as identification of the end user to whom the digital copy is to be sent, and for sending the digital copy provided with the digital watermark to the end user terminal via the connecting device of the network access device via which this end user terminal is connected.

5. Network access device according to claim 4, wherein the network access device has means for decoding an encrypted digital copy which the network access device has received via a connecting device to the telecommunications network.

6. Network access device according to claim 4, wherein the network access device has means for encrypting the digital copy after imprinting of the digital watermark and before sending to the end user terminal.
